(19) United States
(12) Patent Application Publication
(10) Pub. No.: US 2020/0246856 A1
(43) Pub. Date: Aug. 6, 2020

(54) DIE, ROLLER HEMMING SYSTEM AND METHOD FOR PERFORMING ROLLER HEMMING PROCESS ON METAL WORKPIECE

(71) Applicant: SHINKOH CO., LTD., Komaki-city, Aichi (JP)

(72) Inventor: Takahisa MIURA, Kasugai-shi, Aichi-ken (JP)

(73) Assignee: SHINKOH CO., LTD., Komaki-city, Aichi (JP)

(21) Appl. No.: 16/637,262

(22) PCT Filed: Aug. 8, 2018
(86) PCT No.: PCT/JP2018/029787

§ 371 Date: Feb. 6, 2020

(30) Foreign Application Priority Data
Aug. 17, 2017 (JP) 2017-157517

(51) Int. Cl. B21D 19/04; B25J 9/06; B25J 11/00; B21D 39/02; B21D 43/00

(52) U.S. Cl. CPC B21D 19/04; B25J 9/06; B21D 43/003; B21D 39/023; B25J 11/005

(57) ABSTRACT

A die includes a plastic positioning body configured to position a door outer panel to be set in a predetermined posture by being abutted along an edge of an edge of the door outer panel. This positioning body includes a metal inset (or metal inserts) having a higher surface hardness than the plastic at application portion (or portions) where force is applied from areas when these areas, in which deformation resistance at the door outer panel is locally increased, are bent back. The metal insert is in a half-embedded state in which one part of the metal insert(s) is exposed from a surface of the application portion while the remaining part is embedded inside the application portion.

### CROSS-REFERENCE TO RELATED APPLICATIONS

The present application is a U.S. National Phase entry of, and claims priority to, PCT Application No. PCT/JP2018/029787, filed Aug. 8, 2018, which claims priority to Japanese Patent Application No. 2017-157517, filed Aug. 17, 2017, both of which are incorporated herein by reference in their entireties for all purposes.

### BACKGROUND

The present disclosure relates to a die in which a sheet-like metal workpiece is set, a roller hemming system using this die, and a method for performing a roller hemming process on the metal workpiece.

Conventionally, when processing a sheet-like metal workpiece, an edge thereof may be bent back by a press bending process for the purpose of joining the edge of this metal workpiece with an edge of another member or for the purpose of reinforcing the edge of the metal workpiece. A known process method of pressing and bending back the edge of the metal workpiece may be performed by a roller provided on a multi-articulated robot (in this specification, this process method is referred to as “roller hemming”).

A known press bending technique is disclosed in registered Utility-Model publication No. 2581610. In this technique, a plastic press member is interposed between metal sheets to form a die for the press bending process. By including an interposed plastic press member, the weight of the die is reduced, so as to be suitable for being attached to a robot arm. However, in the above technique, the metal sheets cannot be eliminated from the die since they are needed to ensure the strength and accuracy necessary for the press bending process.

### BRIEF SUMMARY

According to the conventional technique disclosed in the above described registered Utility Model publication No. 2581610, the die must include both metal sheets on opposite sides binding the plastic press member. However, the processing load is typically applied only on one predetermined side of the die during the press bending process. The load applied on the other side is negligibly small. Specifically, with regard to the above conventional technique, it is necessary to include metal parts on the die where substantially no load is applied during the press bending process. Inclusion of this essentially non-functional metal part(s) increases the weight of the die.

According to one aspect of the present disclosure, a die, with a metal workpiece set therein, is provided such that a roller hemming process can be performed on an edge of the sheet-like metal workpiece in an area where a deformation resistance against bending back is locally enhanced. Here, roller hemming is a process in which the edge of the metal workpiece is pressed with a roller so as to be bent back. The die includes a plastic positioning body configured to position the metal workpiece in a predetermined posture by being abutted along the edge of the metal workpiece. This positioning body includes a metal inset (or metal inserts) having a higher surface hardness than the plastic at specified pressing portion (or portions) where force is applied to bend back the metal workpiece. The metal insert(s) is in a half-embedded state in which only one part of the metal insert(s) is exposed from a surface of the pressing portion, the remaining portions being embedded.

With the die of the present disclosure, the surface hardness of the positioning body is increased by the metal insert exposed from the surface of the application portion at the application portion. This portion is where a greater force is applied due to the deformation resistance of the workpiece being locally enhanced at the edge thereof. The greater the wear resistance of an object, the greater the surface hardness. Therefore, with the die of the present disclosure, local wear at the application portion may be reduced, even when a greater pressing force is applied as compared to the other parts of the edge when the above-mentioned areas are being bent back. This makes it possible to reduce uneven wear of the positioning body of the die and to extend the life of this die. Further, since the die of the present disclosure is configured to be provided with the metal inserts embedded in the application portions, which is an area where the force is applied to the metal workpiece to bent it back, it is not necessary to provide metal inserts to other portions. Therefore, the weight of the die can be reduced.

Further, in addition to increasing surface hardness, a known method of enhancing the wear resistance of an object includes reducing the friction coefficient of the surface of the object. Here, since the adopted method is increasing the surface hardness of the positioning body, it is not necessary to reduce the frictional coefficient of the surface of the positioning body. Therefore, it is possible to reduce the potential displacement of the metal workpiece due to slipping on the positioning body.

According to one preferable embodiment of the die, the positioning body serves to determine a position of the metal workpiece, the metal workpiece having a plate thickness of more than or equal to 0.5 mm and less than or equal to 1 mm at its edge. Further, the application portion(s) of the die is configured to extend along the edge of the metal workpiece, the metal workpiece having a width of less than or equal to 7 mm at a bent-back portion having being bent back by roller hemming.

In the present disclosure, when the sheet-like metal workpiece has a plate thickness of more than or equal to 0.5 mm and less than or equal to 1 mm at its edge, a portion of the metal workpiece will likely have a greater deformation resistance during a roller hemming process merely depending on the width of the bent-back portion, regardless of the constituent material of this metal workpiece. Accordingly, it is possible to determine an arrangement of the metal inserts in the positioning body of the die merely by the appearance of the final metal workpiece. Therefore, modifying the design of the die can be easily carried out when changing the design of the metal workpiece, without needing trial and error to determine the arrangement of the metal inserts.

Further, the positioning body may preferably be configured by assembling a plurality of plastic blocks, made of a hard urethane resin without voids, with the metal insert(s).

The portions of the positioning body along the metal workpiece during the roller hemming process are required to have the property of being hard to crack or chip (i.e., having toughness) and having wear resistance. For example, a hard urethane resin is known as a plastic having excellent wear resistance and toughness. When casting a hard urethane resin, voids may be formed that often lead to cracks. Accordingly, a high level of technique is necessary to prevent formation of the voids in a casted product having a relatively complex shape (for example, a shape in which an insert or inserts is embedded).

Here, according to the above structure, it is possible to produce a positioning body having a relatively complex shape out of plastic blocks having a relatively simple shape. Therefore, when producing the above described positioning body using a hard urethane resin, a high level of technique is not necessary to prevent formation of the voids in the final relatively complex shape.

According to one of the alternative preferred embodiments, a positioning body serves to determine a position of a metal workpiece with a corner (or corners) having a trimmed edge shape. Further, the application portion(s) is configured to be placed along a portion (or application portions) at the edge of the metal workpiece made to have a narrower bent-back width, due to being trimmed, after roller hemming.

When roller hemming the metal workpiece having the above shaped corners, the edges at the corners may be formed with a pre-trimmed shape in order to avoid the bent-back edge at the corners becoming creased during the deformation process. Further, it is empirically known that the deformation resistance at this edge during a roller hemming process on the metal workpiece becomes greater as the bent-back width of the edge becomes narrower. Here, according to the above constitution, an arrangement of the metal inserts in the positioning body of the die may be determined in accordance with a configuration of the portion of the metal workpiece having a trimmed shape. Therefore, design modification can be easily carried out when changing the design of the metal workpiece, without needing trial and error to determine the arrangement of the metal inserts.

According to another alternative preferred embodiment, the positioning body serves to determine the position of a metal workpiece having a trapezoidal groove at the edge. The trapezoidal groove may be in a shape where a part of the edge is notched. The application portion(s) of the die is configured to be placed along a portion of the edge of the metal workpiece during roller hemming, the portion having a narrower bent-back width due to the trapezoidal groove.

When processing a sheet-like metal workpiece, a bending line may be formed on a sheet surface of the metal workpiece by bending the entire metal workpiece prior to roller hemming. In this case, the edge around the bending line may be formed having a notch with the shape of a trapezoidal groove. This helps to prevent the edge of the metal workpiece from becoming creased during roller hemming. Further, it is empirically known that the deformation resistance at this edge increases during the roller hemming process on the metal workpiece when the bent-back width at the edge becomes narrower. Here, according to the above constitution, the arrangement of the metal inserts in the positioning body of the die may be determined in accordance with a configuration of the trapezoidal grooves in the metal workpiece. Therefore, design modification can be easily carried out when changing the design of the metal workpiece, without needing trial and error to determine the arrangement of the metal inserts.

Further, a method for performing a roller hemming process is also disclosed. The disclosed process is one in which the roller hemming process is carried out on a sheet-like metal workpiece having portions of the edge where deformation resistance against bending back is locally increased. The bending back may be performed by pressing and bending back the edge of this metal workpiece with a roller. This roller hemming system includes a die in which a metal workpiece can be set, such that the roller hemming can be carried out. Further, the roller hemming system includes a supporting means configured to support the metal workpiece in a state with the edge of this metal workpiece being freely accessible. Furthermore, the roller hemming system includes a robot having the roller and is configured to control pressing the edge of the metal workpiece with this roller. The die includes a plastic positioning body configured to position the metal workpiece in a predetermined posture by being abutted to and along an edge of the metal workpiece. This positioning body includes a metal inset (or metal inserts) having a higher surface hardness than the plastic. The metal inset(s) is provided at an application portion (or application portions), where forces applied to the metal workpiece for bending them back are stronger. The metal insert(s) is half-embedded, in which some part of the metal insert(s) is exposed from a surface of the application portion(s) while the remaining part is embedded inside the application portion(s). The robot serves to press the edge at the metal workpiece with the roller from a side of the workpiece opposite to the positioning body. The metal insert(s) is set in the die and placed along the above-mentioned areas.

With the roller hemming system according to the present disclosure, it is possible to carry out the roller hemming process on the metal workpiece using a die according to the above-mentioned present disclosure.

According to one of the preferred embodiments of the roller hemming system, the roller hemming system includes a manipulator for controlling the position and the posture of the die. Further, the supporting means serves to bring this metal workpiece into a lifted state by supporting the metal workpiece. Further, the manipulator allows the positioning body of the die to cover the supported metal workpiece. The metal insert(s) is positioned along the above-described areas of this metal workpiece, so that the metal workpiece is set in the die.

According to the above constitution, the roller hemming process can be carried out on the metal workpiece using the die according to the above-described present disclosure. The roller hemming process is carried out while the metal workpiece is being supported by the supporting means, the supporting means being different from the die. In this way, it is possible to reduce the weight of the die itself. Therefore, since the die does not require a supporting structure to the metal workpiece, the handling performance of the manipulator for controlling the position and the posture of the die can be improved. Therefore, arrangement changing work of the die during operation the manipulator is improved.

Also disclosed is a method for performing the roller hemming process on the metal workpiece in which the roller hemming process is carried out on the sheet-like metal workpiece having areas at the edge where deformation resistance against bending back is locally increased. The roller hemming process may be carried out by pressing and bending back the edge of this metal workpiece with a roller. In this method, a die including a later described plastic positioning body and a metal insert (or metal inserts) is used. Here, the plastic positioning body serves to dictate the position of the metal workpiece in a predetermined posture. The positioning body may be abutted along an edge of the metal workpiece. Further, the metal insert(s) may be half-embedded into the positioning body such that some part of the metal insert(s) is exposed from a surface of the positioning body while the remaining portion is embedded in the positioning body. In the above method for performing the roller hemming process on a metal workpiece, the metal workpiece is set in the die such that the metal insert(s) of the die is placed along the area having locally greater bend back resistance. With the metal workpiece being set in the die, the edge of the metal workpiece is pressed by the roller from the side opposite to the positioning body.

In the method for performing the roller hemming process on the metal workpiece according to the present disclosure, the roller hemming process can be performed on the metal workpiece using the die according to the above-described present disclosure.

In the method for performing the roller hemming process on the metal workpiece, it is favorable for the die to cover the metal workpiece being supported by the supporting means in a lifted state with a supporting means independent of the die. The die may be positioned to place the metal insert(s) along the above-described area of the metal workpiece when the metal workpiece is set in the die.

According to the above method, a roller hemming process can be performed on the metal workpiece using the die according to the above-described present disclosure. The roller hemming process can be performed while the metal workpiece is supported by the supporting means, which is different from the die. In this way, it is possible to reduce the weight of the die itself. Since it is not needed to provide a structure for supporting the metal workpiece on the die, the handling performance of the die can be improved. Therefore, it is possible to perform a roller hemming process on the metal workpiece with improved operability of an arrangement changing work of the die.

### BRIEF DESCRIPTION OF THE DRAWINGS

FIG. 1 is a front view showing a roller hemming system 20 according to one embodiment of the present disclosure.

FIG. 2 is a left side view showing the roller hemming system 20 of FIG. 1.

FIG. 3 is a plan view showing the roller hemming system 20 of FIG. 1.

FIG. 4 is a perspective view showing an operation state of the roller hemming system 20.

FIG. 5 is a perspective view showing a door inner panel 90A and a door outer panel 90 processed by the roller hemming system 20.

FIG. 6 is a front view showing a die 10 of FIG. 1.

FIG. 7 is a left side view showing the die 10 of FIG. 1.

FIG. 8 is a plan view showing the die 10 of FIG. 1.

FIG. 9 is an exploded perspective view of a positioning body 11 of FIG. 8.

FIG. 10 is an explanatory view illustrating a state in which a door outer panel 90 of FIG. 5 is set in the die 10 of FIG. 4.

FIG. 11 is an enlarged view of section A of FIG. 10.

FIG. 12 is an enlarged view of section B of FIG. 10.

FIG. 13 is an explanatory view illustrating a motion of a vertical multi-articulated robot 23B of FIG. 4.

FIG. 14 is an explanatory view illustrating the motion of the vertical multi-articulated robot 23B of FIG. 4.

FIG. 15 is an explanatory view illustrating a method for performing a roller hemming process on the door outer panel 90 using a fixture 20A of FIG. 2

### DETAILED DESCRIPTION

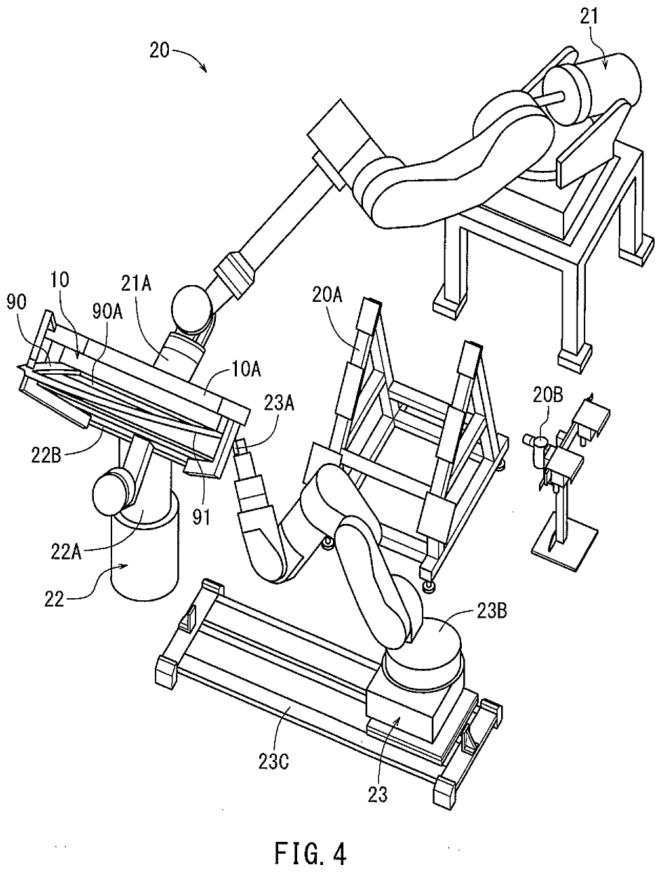

Hereinafter, a roller hemming system 20 according to one embodiment for carrying out the present disclosure will be described with reference to the drawings. This roller hemming system 20 serves to perform a roller hemming process on a door outer panel 90, the door outer panel 90 originally being formed as a sheet-like metal workpiece, such that an edge 91 is bent back, for instance as illustrated in FIG. 4.

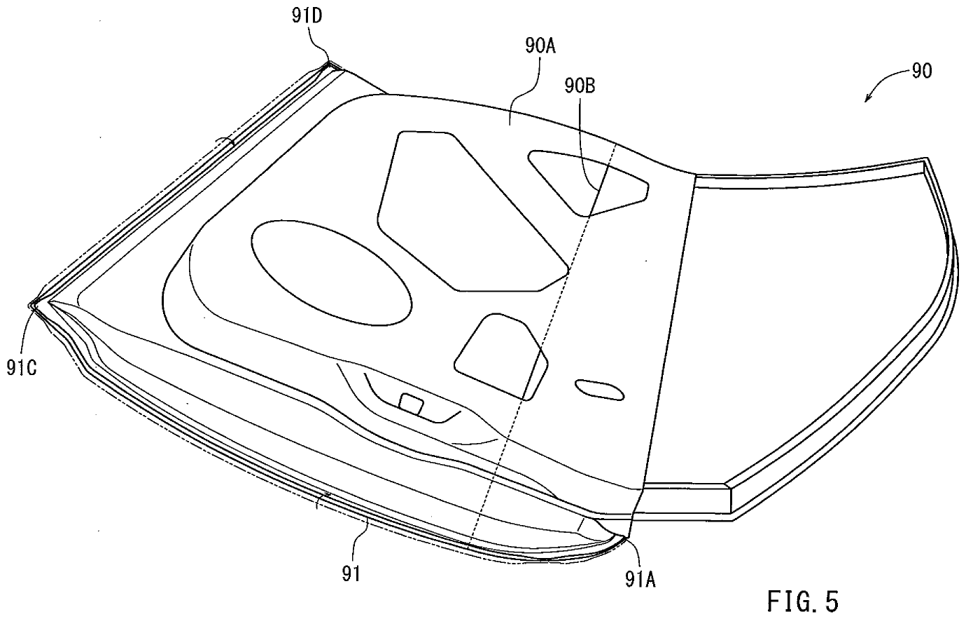

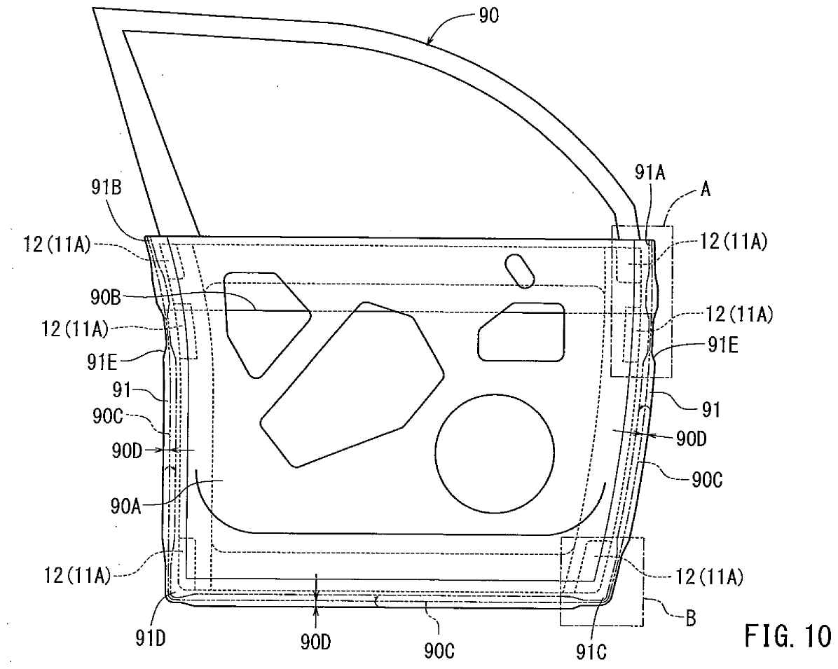

This door outer panel 90 may be formed by processing a metal sheet (specifically, for example, a cold-rolled steel sheet or an aluminum sheet) with a press machine. As shown in FIG. 5 and FIG. 10, the door outer panel 90 may be shaped to form an outer shell of a front door and door sash of a passenger automobile. In the present embodiment, the door outer panel 90 is formed to have a sheet thickness of greater than or equal to 0.5 mm and less than or equal to 1 mm at its edge 91.

Further, a linear bending line 90B may be formed on the door outer panel 90 by bending an entire part of an outer shell of the door outer panel 90 to form a raising (e.g., raising toward a back side of the sheet as viewed in FIG. 10) on an outer side of the outer shell. This bending line 90B may be formed to extend from the edge 91 of the front side of the outer shell (e.g., right side as viewed in FIG. 10) to the edge 91 of the rear side of the outer shell (e.g., left side as viewed in FIG. 10) in the front to rear direction of the outer shell (e.g., left-right direction as viewed in FIG. 10).

Further, a door inner panel 90A may be formed by processing a rectangular metal sheet with a press machine. The door inner panel 90A may be shaped to form a door rim of the front door for a passenger automobile. The door inner panel 90A may be overlaid on the part of the door outer panel 90 constituting the outer shell. The door inner panel 90A and the door outer panel 90 generally define an outer contour of the front door of the passenger automobile as a whole. The door outer panel 90 may be attached to the door inner panel 90A by bending back one or more edge 91 of the door outer panel 90 about the corresponding edge of the door inner panel 90A by roller hemming.

Here, as shown in FIG. 10, corners 91A, 91B, 91C, 91D of the edges 91 of the door outer panel 90 may be positioned close to each of the corresponding four corners of the door inner panel 90A. The corners 91A, 91B, 91C, 91D may be beveled so as to form a shaped corner. In the present embodiment, the corners 91A, 91B positioned at the upper edge of the outer shell are formed to have a beveled ogee (Hyoutan) profile. The corners 91C, 91D positioned at the lower edge of the outer shell are formed to have a compound beveled shape, for instance a shape in which corners of both sides of an ovolo (Karato) profile are cut off by wide trimming. In the present embodiment, the wide beveled portions of the compound beveled shape may be formed such that the bevel length 91F (see FIG. 12) will be, for example, 20 mm.

Further, a trapezoidal groove 91E may be positioned at a portion where the bending line 90B extends from the edge 91 of the door outer panel 90. The trapezoidal groove 91E may be formed by notching a part of the edge 91 in the thickness direction (e.g., in a direction from the front side to the back side of the sheet of FIG. 10). This trapezoidal groove 91E may prevent the edge 91 from being creased during the bending process for forming the bending line 90B of the door outer panel 90.

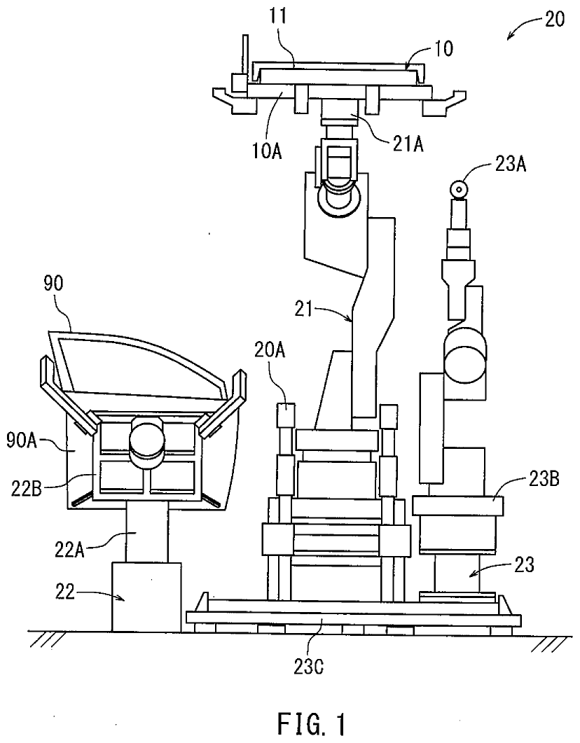

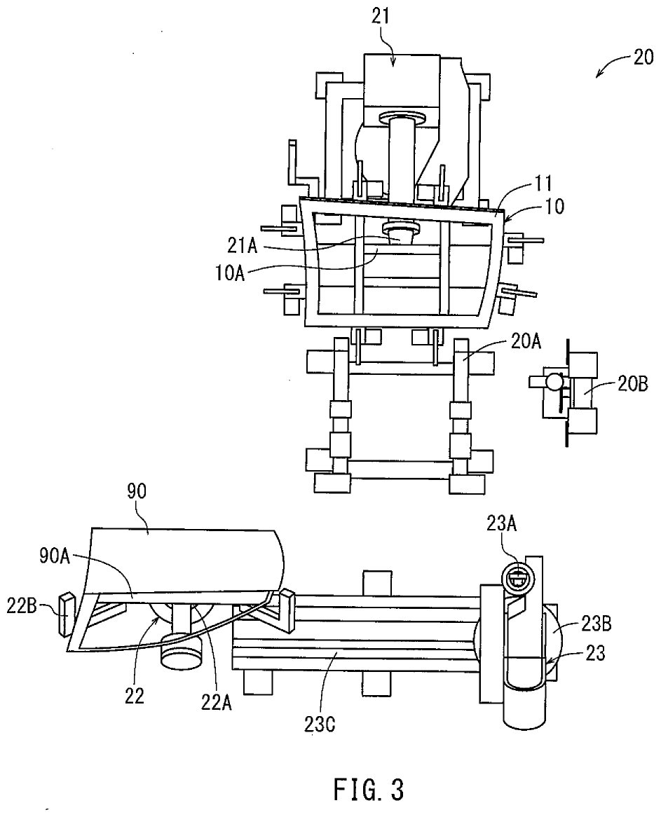

The roller hemming system 20 includes a linear rail 23C and a carriage 23. The carriage 23 may be a robot reciprocally moveable on the rail 23C, as shown in FIGS. 1 to 4. This carriage 23 may include a 6-shaft vertical multi-articulated robot 23B with a roller 23A at the front end thereof.

Further, the roller hemming system 20 may include a jig 22. The jig 22 may serve as a supporting means capable of supporting the door outer panel 90 and the door inner panel 90A so as to be overlaid with each other and in a lifted-up state. This jig 22 is structured to have a fixture 22B attached on a manually operable turn table 22A so that the door inner panel 90A can be horizontally turned together with the door outer panel 90, while the door outer panel 90 is leaning against this fixture 22B.

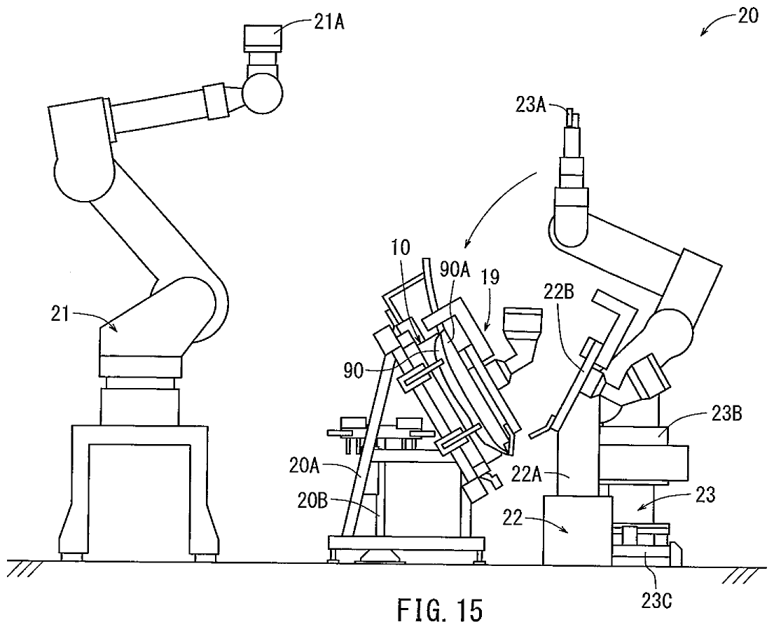

Further, the roller hemming system 20 may include a die 10. The door outer panel 90 is set within the die 10 when performing a roller hemming process, as shown in FIG. 4. Further, the roller hemming system 20 may include a 6-shaft vertical multi-articulated robot 21 with a hand 21A at the front end thereof. This vertical multi-articulated robot 21 is configured to serve as a manipulator for controlling the position and the posture of the die 10. For instance, the vertical multi-articulated robot 21 may manipulate the die 10 by grasping the die 10 with its hand 21A and lifting the die 10. In the present embodiment, the vertical multi-articulated robot 21 is made to also be able to grasp and handle an object (for example, a pressing member 19 shown in FIG. 15) other than the die 10.

Further, the roller hemming system 20 may include a fixture 20A allowing the die 10 to be placed in a state leaning in one predetermined direction, as shown in FIG. 15. This fixture 20 may be installed between the rail 23C and the vertical multi-articulated robot 21, in such an orientation that the die 10 can also be leaned in a direction from the side of the rail 23C (e.g., leaned from the right side as viewed in FIG. 15).

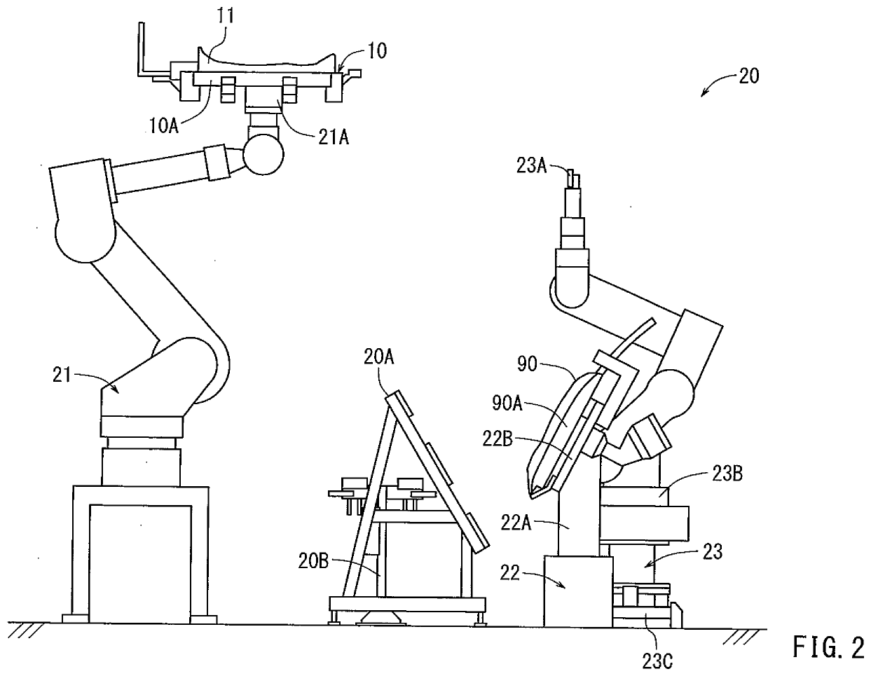

Further, the roller hemming system 20 may include a control unit 20B, as shown in FIGS. 2 to 4. This control unit 20B is an apparatus for collectively controlling the motion of the movable parts of each component of the above-described roller hemming system 20.

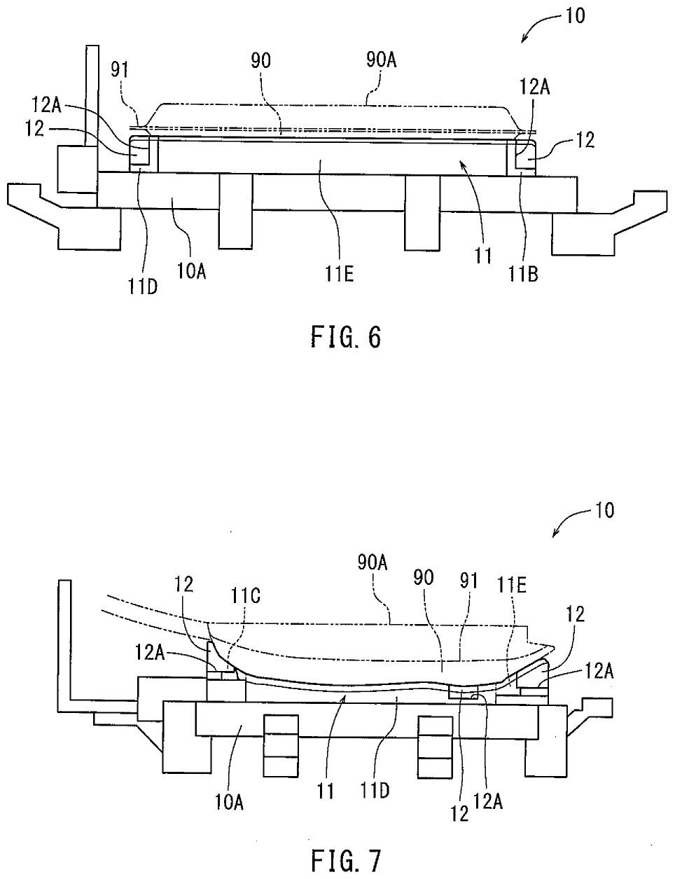

The die 10 may include a handle 10A structured to enable the hand 21A of the vertical multi-articulated robot 21 to grasp the die 10. Further, the die 10 may include a positioning body 11 configured to form a torus body which can come in contact with the edge 91 of the door outer panel 90, as shown in FIGS. 6 to 8. In the present embodiment, the handle 10A is configured to form a frame with parallel crosses, so as to allow the positioning body 11 to be fitted therein.

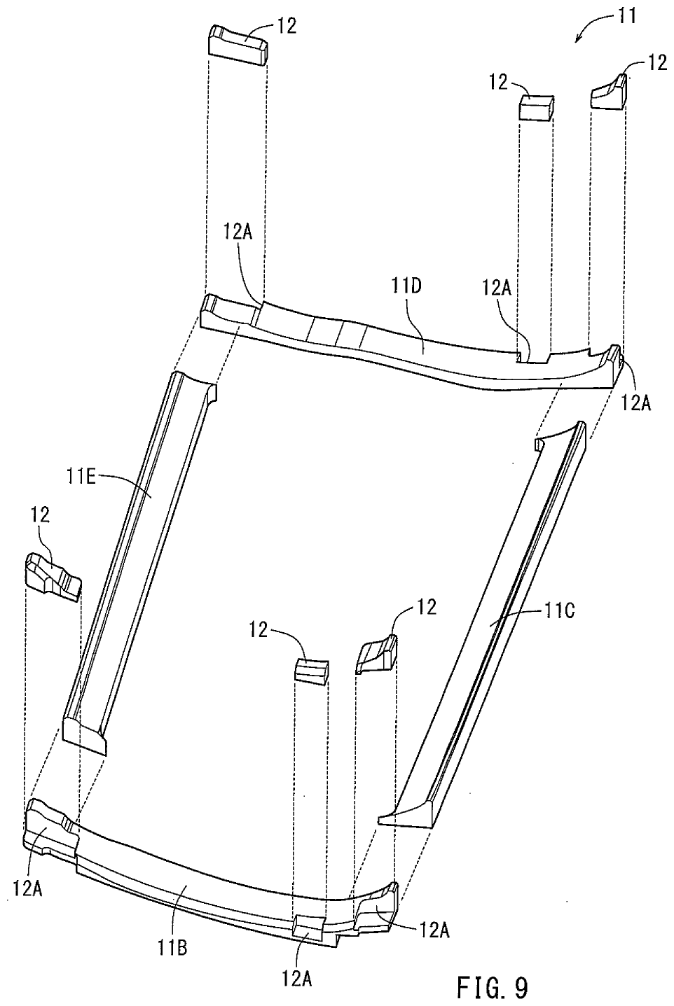

As shown in FIG. 9, the positioning body 11 may be structured by assembling four plastic blocks 11B, 11C, 11D, 11E together with six metal inserts 12. The plastic blocks 11B, 11C, 11D, 11E may be formed in generally a rod shape, and the six metal inserts 12 may be formed in generally a block. The four plastic blocks 11B, 11C, 11D, 11E may be made by cutting out a plastic block without voids. The four plastic blocks 11B, 11C, 11D, 11E may each generally have a rod shape, which is a relatively simple shape. A hard urethane resin block excellent in both wear resistance and toughness may be favorably used for these plastic blocks. The shore D value of this hard urethane resin is preferably greater than or equal to 80, and more preferably greater than or equal to 80 and less than or equal to 90. These surface hardness values are represented as a shore D value, which is the hardness according to a Durometer D test specified in ISO 868: 2003. RAKU-TOOL® WB-1250, RAKU-TOOL® CB-6503, or RAKU-TOOL® WB-1210 (RAKU-TOOL is a registered trademark for hard resins manufactured by Rampf Holding GmbH & Co. KG) are examples of such urethane resins with the desired surface hardness. If the surface hardness of the hard urethane resin is less than 80, the plastic blocks 11B, 11C, 11D, 11E may become severely worn or deteriorated. This may result in the plastic blocks 11B, 11C, 11D, 11E becoming deformed or damaged relatively early.

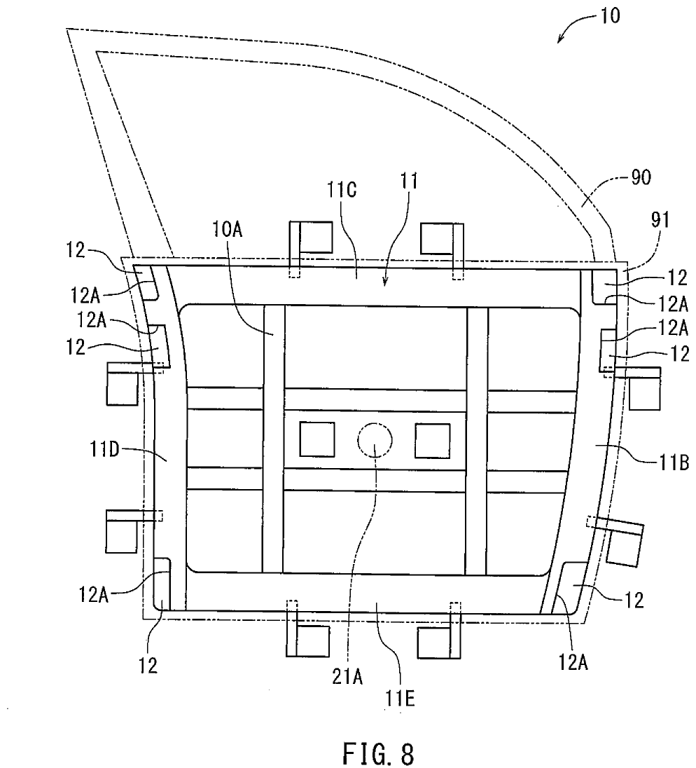

The plastic blocks 11B, 11C, 11D, 11E may be joined by butt joints and bonded together with an adhesive, such that each block can be placed along a front edge, an upper edge, a rear edge, and a lower edge of the door outer panel 90 (see FIG. 8). Three recesses 12A may be formed in the plastic blocks 11B, 11D having exposed end faces at these butt joints. One metal insert 12 is inserted in each of these recesses 12A. Here, each of the metal inserts 12 is located corresponding to one of the corners 91A, 91B, 91C, 91D or corresponding to the trapezoidal groove 91E of this edge 91, when the positioning body 11 is abutted along the edge 91 of the door outer panel 90 (see FIG. 10).

The six metal inserts 12 may be made by cutting sintered carbon steel into blocks. The sintered carbon steel may be a metal having a greater surface hardness than that of each of the above mentioned hard urethane resins. When the sintered carbon steel surface hardness is represented as an HRC, which is the hardness value of a Rockwell hardness test for scale C specified in ISO 6508-1:2016, the HRC value of this sintered carbon steel is preferably greater than or equal to 60, more preferably greater than or equal to 60 and less than or equal to 65. Examples of such sintered carbon steel may be S50C Carbon Steel for Mechanical Structural Use or SX105V (product name) manufactured by Aichi Steel Corporation. When the surface hardness of the sintered carbon steel is less than 60, a deformation problem of the metal insert 12 may occur relatively early.

The metal inserts 12 are fitted in the plastic blocks 11B, 11D. For instance, the metal inserts 12 may be fitted by a flat-inlay process in the plastic blocks 11B, 11D, with the plastic blocks 11B, 11D functioning as base members. Here, the term “flat-inlay” refers to as a technique in which inserts (e.g., the metal inserts) are fitted into the recesses (e.g., the recesses 12A of FIG. 9) of a base member and subsequently have their surfaces shaped, for example by using a grinder, so as to be flush with the base member. Therefore, the metal inserts 12 fitted in the plastic block 11B are brought into a partially-embedded state, in which some parts of these metal inserts 12 are exposed from the surface of the plastic block 11B while the remaining parts are embedded inside the plastic block 11B. Further, the metal inserts 12 fitted in the other plastic block 11D are also brought into a partially-embedded state, in which some parts of this metal inserts 12 are exposed from the surface of the plastic block 11D while the remaining parts are embedded inside the plastic block 11D.

Next, an embodiment of an operation of performing a roller hemming process on a door outer panel 90 by an operator (not shown) using the above described roller hemming system 20 will be described. Firstly in this operation, the operator horizontally rotates the turn table 22A of the jig 22 so as to orient the fixture 22B on this turn table 22A toward the front side of the operator. Subsequently, the operator leans the door inner panel 90A against the fixture 22B. Then, the door outer panel 90 is overlaid on the door inner panel 90A, such that the door outer panel 90 is supported by the fixture 22B of the jig 22. In such a position, the edge 91 of the door outer panel 90 is brought into a state so as to be suspended by the fixture 22B and be freely accessible.

Next, the operator horizontally rotates the turn table 22A of the jig 22 so as to orient the fixture 22B, as well as the door outer panel 90 supported by this fixture 22B, toward the side of the vertical multi-articulated robot 21 (toward the left side as viewed in FIG. 2). Subsequently, the operator starts the roller hemming system 20.

With the roller hemming system 20 started, the hand 21A of the vertical multi-articulated robot 21 grasps the die 10 and positions the die 10 to cover the door outer panel 90. Thus, the die 10 covers the door outer panel 90 from the side of the positioning body 11 so that the positioning body 11 is placed along the edge 91 of the door outer panel 90.

The positioning body 11 positions the correct orientation of the door outer panel 90 by being abutted to a part of the plate surface of the door outer panel 90 radially inward of the edge 91. The positioning body 11 is also oriented to allow the edge 91 to be accessible. As a result, the die 10 is set on the door outer panel 90 such that roller hemming can be performed. In this state, each of the metal inserts 12 is positioned so as to be placed along the edge 91 of the door outer panel at a corresponding corner 91A, 91B, 91C, 91D or the trapezoidal groove 91E (see FIG. 8).

Furthermore, the roller hemming system 20 allows the carriage 23 to move on the rail 23C within a predetermined processing position range. This processing position range is set such that the roller 23A on the vertical multi-articulated robot 23B can reach any part of the edge 91 of the door outer panel 90, while being positioned by the die 10.

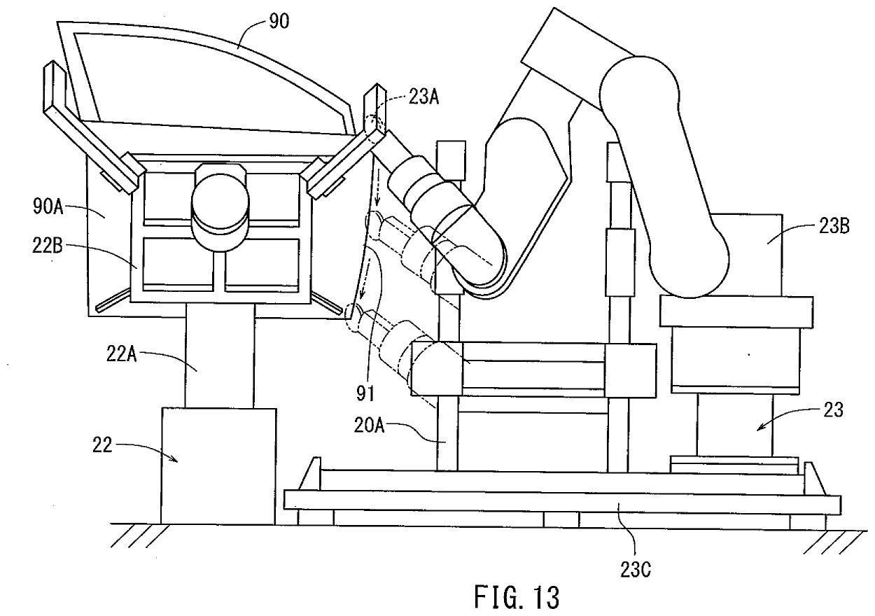

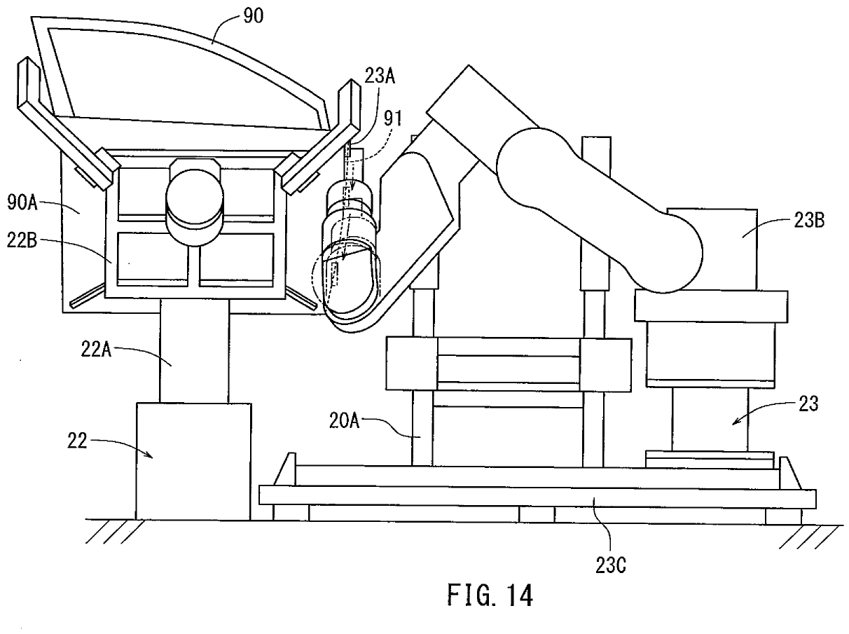

Moreover, the roller hemming system 20 moves the vertical multi-articulated robot 23B on the carriage 23 so that the roller 23A presses the edge 91 of the door outer panel 90. At this time, as shown in FIG. 13 and FIG. 14, the roller 23A is controlled by the vertical multi-articulated robot 23B so that it presses each side of the edge 91 twice. The edge 91 is pressed from the side opposite the positioning body 11 (see FIG. 8).

Here, the first pressing operation by the roller 23A is carried out such that the edge 91 is bent along the bending line 90C. The bending line 90C is virtually determined to correspond to be along a rim of the positioning body 11. The edge 91 of the door outer panel 90 is deformed so that it forms a flange like shape extending generally upward. Further, the second pressing by the roller 23A is carried out such that the edge 91 is bent back toward an edge of the door inner panel 90A. The edge 91 is further crushed toward the edge of the door inner panel 90A. In this way, the roller hemming system 20 joins the edge 91 of the door outer panel 90 with the edge of the door inner panel 90A by the roller hemming process (see FIG. 5).

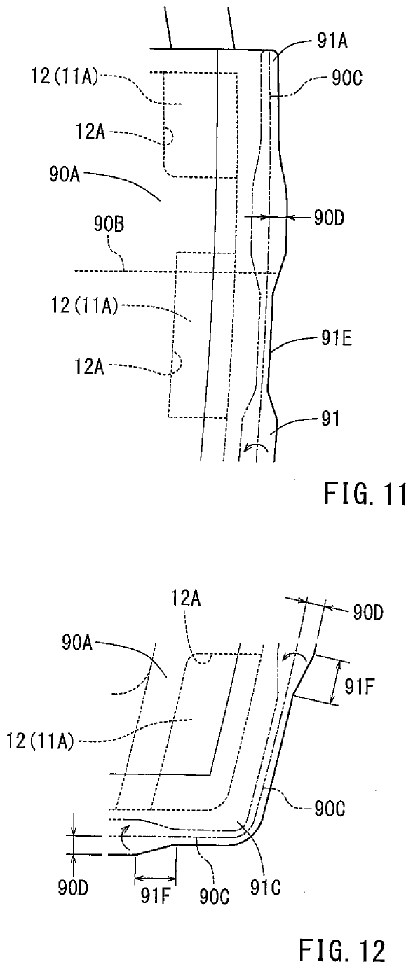

As shown in either of FIGS. 10 to 12, portions of the edge 91 of the door outer panel 90 may be configured to have a shape corresponding to the shape of the edge of the door inner panel 90A. For instance, some parts of the edge 91 of the door outer panel 90, for instance those defining the corners 91A, 91B, 91C, 91D, are formed to have a reduced bent-back width 90D as a result of their trimmed shape. These portions are areas where the deformation resistance against bending back during the roller hemming process is locally increased. Another example of a part of the edge 91 of the door outer panel 90 having a reduced bend-back width 90 D is the area defining the trapezoidal groove 91E. Because of the reduced bent-back width 90D, the trapezoidal groove 91E is an area where the deformation resistance against bending back during the roller hemming process is locally increased.

In the present embodiment, the bent-back width 90D at some parts of the edge 91 of the door outer panel 90, for instance those defining the corners 91A, 91B, 91C, 91D or the trapezoidal groove 91E, is less than or equal to 7 mm. In particular, the bent-back width 90D at some parts, for instance between the sides of the compound trim at each of the corners 91A, 91B, 91C, 91D and at a bottom part of the trapezoidal groove 91E, are set to be between 3 mm and 4 mm, inclusive. However, some parts of the edge 91 of the door outer panel 90, for instance those excluding the corners 91A, 91B, 91C, 91D or the trapezoidal groove 91E, are have the bent-back width 90D greater than 7 mm and less than 13 mm.

Therefore, some parts of the positioning body 11 of the die 10 in which the door outer panel 90 is set, for instance along the corners 91A, 91B, 91C, 91D or the trapezoidal groove 91E, serve as application portions 11A where the applied force during the roller hemming process is particularly strong. Because these application portions 11A have configuration with the metal inserts 12 arranged therein, the pressing force exerted when bending back these areas of the edge 91 is received by the metal inserts 12.

After completion of pressing of the edge 91 of the door outer panel 90 with the roller 23A, the positions and postures of the vertical multi-articulated robot 21 and the carriage 23 are restored to their condition immediately after starting the roller hemming system 20. As a result, the door outer panel 90 is released from a state of being set in the die 10, so that it can be freely removed from the fixture 22B.

Next, when the operator confirms that the door outer panel 90 is released from the die 10, the turn table 22A of the jig 22 is horizontally turned so that the fixture 22B is oriented to the front side of the operator. Subsequently, the operator removes the door outer panel 90, which is now attached to the door inner panel 90A as a result of the roller hemming process, from the fixture 22B. Then, the operator stops the roller hemming system 20. However, the operator may perform the roller hemming process on a plurality of door outer panels 90 by repeating the above-described operations.

In the operation for performing the roller hemming process, the roller hemming system 20 performs the roller hemming process while the door outer panel 90 leans against the fixture 22B of the jig 22. However, the die 10 may instead be located on the fixture 20A for performing the roller hemming process on the door outer panel 90. Hereinafter, a method for performing this roller hemming process will be described.

When performing this roller hemming process, the operator operates a control unit 20B in advance and changes the operations of each the components of the roller hemming system 20. Further, the operator prepares a pressing member 19 in advance. The pressing member 19 is set such that the door outer panel 90 may be pushed into the die 10 by pressing on the door outer panel 90. This pressing member 19 is prepared in a predetermined location (not shown) so as to be within reach of the hand 21A of the vertical multi-articulated robot 21.

With the door inner panel 90A being laid over the door outer panel 90 ready at hand, the operator starts the roller hemming system 20. Subsequently, the roller hemming system 20 moves the vertical multi-articulated robot 21 to allow the die 10 being held by the hand 21A of this vertical multi-articulated robot 21 to be placed on and leaned against the fixture 20A. Accordingly, the positioning body 11 of the die 10 is oriented on a side of the die 10 opposite to the fixture 20A, thereby enabling the door outer panel 90 to be capable of leaning against the positioning body 11.

Subsequently, the hand 21A of the vertical multi-articulated robot 21 releases the handle 10A and is extended toward and grasps the pressing member 19 located at the predetermined location. Concurrently, the operator leans the door outer panel 90, including the overlaid door inner panel 90A, against the positioning body 11 of the die 10, which is now leaning against the fixture 20A. At this moment, the operator positions the corners 91A, 91B, 91C, 91D and the trapezoidal groove 91E of the edge 91 of the door outer panel 90 so as to be placed along the metal inserts 12 of the die 10.

The vertical multi-articulated robot 21 grasping the pressing member 19 then moves and release the pressing member 19 over the die 10. Because the door outer panel 90 is leaning on the die 10, the pressing member 19 is positioned to press on both the door outer panel 90 and the door inner panel 90A. As a result, the door outer panel 90 is set in the die 10 so that the roller hemming process can be performed.

Subsequently, the vertical multi-articulated robot 23B on the carriage 23 is moved such that its roller 23A presses the edge 91 of the door outer panel 90. As a result, the edge 91 of the door outer panel 90 and the edge of the door inner panel 90A are fixed to each other by the roller hemming process. If the vertical multi-articulated robot 23B and the vertical multi-articulated robot 21 are anticipated to interfere with one another when moving the vertical multi-articulated robot 23B, the vertical multi-articulated robot 21 may be retracted before moving the vertical multi-articulated robot 23B, as shown in FIG. 15.

After completion of the roller 23A pressing the edge 91 of the door outer panel 90, the roller hemming system 20 moves the vertical multi-articulated robot 21 so that its hand 21A may grasp the pressing member 19. The pressing member 19 is then returned to its predetermined location. In this way, the door outer panel 90 is released from the state being set in the die 10 and can be freely removed from this die 10. The operator may then remove the door outer panel 90 and the now attached door inner panel 90A from the die 10.

The vertical multi-articulated robot 21, which has now returned the pressing member 19 to the predetermined location, may extend its hand 21A toward and grasp the die 10. Since the door outer panel 90 was already removed from the die 10, the vertical multi-articulated robot 21 can freely grasp and lift the die 10.

The roller hemming system 20 then returns the positions and the postures of the carriage 23, the vertical multi-articulated robot 21, and the die 10 to the state immediately after starting the roller hemming system 20. In response, the operator stops the roller hemming system 20. However, the operator may perform the roller hemming process on a plurality of the door outer panels 30 by repeating the above operations.

The surface hardness of portions of the above-described die 10 are higher due to the metal inserts 12 exposed from the surface of the application portions 11A. These application portions 11A correspond to areas where a greater force needs to be applied due to the deformation resistance of the edge 91 being locally higher. Here, the areas are those having a trimmed shape, specifically, for example, the parts of the corners 91A, 91B, 91C, 91D and the part defining the trapezoidal groove 91E. Therefore, local wear at the application portions 11A of the die 10 may be reduced, even when a relatively greater pressing force is applied when the corresponding areas of the edges 91 are being bent back. Therefore, it is possible to extend the life of die 10, for instance by inhibiting uneven wear of the plastic positioning body 11 of the die 10. Further, since increasing the surface hardness of the positioning body 11 is adopted as a method for making the positioning body 11 of the die 10 harder to wear out, it is not necessary to reduce the frictional coefficient of the surface of this positioning body 11. Therefore, the potential displacement of the door outer panel 90 caused by slipping on the positioning body 11 can be reduced.

Further, the metal inserts 12 are embedded in the application portions 11A of the die 10. That is, the die 10 is structured with the metal inserts 12 only at the portions where a larger force is applied to the areas of the door outer panel 90 being bent back. Since the metal inserts 12 are not embedded at the portions where the force applied to the door outer panel 90 is low, the weight of the die 10 can be reduced. Namely, the die 10 is constituted of a combination of metal and plastic, eliminating the metal parts from the areas to which the load is not forcefully applied, thereby reducing the weight of the die 10.

Further, the location of the metal inserts 12 in the positioning body 11 of the die 10 can be determined only based on the appearance of the door outer panel 90 (specifically, for example, the thickness of the edge 91 and the bent-back width 90D or the relative arrangement of the areas). Therefore, it is possible to facilitate developing a new die 10 when modifying the design of the door outer panel 90, for instance without necessitating repeated trial and error to determine the proper arrangement of the above metal inserts 12.

Further, the positioning body 11 of the die 10 can be made with the plastic blocks 11B, 11C, 11D, 11E having a relatively simple shape (specifically, for example, a rod shape). This is possible even though the embedded metal inserts 12 have a relatively complex shape. Therefore, when producing the positioning body 11 using a hard urethane resin, for example, which is a plastic excellent in both wear resistance and toughness, a high level of technique is not necessary to prevent voids forming in casted products. Void formation is especially problematic for hard urethane resins having a relatively complex shape.

Further, the above-described die 10 of the above-described roller hemming system 20 and the roller hemming process can be used with the door outer panel 90 while the door outer panel 90 is supported by a supporting means (specifically, for example, the jig 22) separate from this die 10. As a result, it is possible to reduce the overall weight of the die 10 itself, since there is no need to provide an integrated structure for supporting the door outer panel 90. This improves the handling performance of the die 10. Therefore, the handling performance of the vertical multi-articulated robot 21, which controls the position and the posture of the die 10, is improved. Therefore, the roller hemming system 20 can achieve improved operability of arrangement changing work of the die 10 by moving this vertical multi-articulated robot 21.

The present disclosure is not limited to have the appearance and structure described in the above-described embodiment. Various modifications, additions, or eliminations are possible without departing from the scope of the present disclosure. For example, the following various embodiments may be carried out.

(1) The metal workpiece, which can be subjected to the roller hemming process according to the present disclosure, is not limited to a door outer panel having a bending line. More particularly, according to the present disclosure, the roller hemming process can be performed, for example, on the edge of the door outer panel without a bending line. For example, with regard to this case, the trapezoidal grooves in the edge of the door outer panel and the metal inserts provided in the positioning body of the die corresponding to this trapezoidal groove can be omitted. Further, according to the present disclosure, the roller hemming process can be performed, for example, on the edge of the disk-shaped metal workpiece without corners. In this case, since the edge of the metal workpiece does not need to have a trimmed shape, the metal inserts corresponding to the portions with this trimmed shape can be omitted.

(2) The roller hemming process carried out in the above-described embodiment is adopted for fixing the door outer panel to the door inner panel by bending up the edge of the door outer panel to have a flange shape, then bending this edge back toward the edge of the door inner panel, and finally crushing this edge of the door outer panel toward the door inner panel. However, the roller hemming process according to the present disclosure is not limited to those steps described above. Specifically, the roller hemming process according to the present disclosure, for example, may have the flange formed in advance. This allows the door outer panel to be affixed to the door inner panel merely by bending back the seam formed at the edge of the door outer panel and crushing this edge toward the door inner panel. Further, the roller hemming process according to the present disclosure may be a folding edge process for reinforcing the edge of the metal workpiece. For instance, reinforcement may be achieved by bending back and crushing the edge of the metal workpiece optionally formed in a plate-shape, without it interlocking with another member. Further, the roller hemming process according to the present disclosure may be a rolling edge process in which the edge of the metal workpiece optionally formed in a plate-shape is bent back without this edge being crushed.

(3) The metal inserts in the die of the present disclosure do not need to be fitted by a flat-inlay process, where the plastic blocks constituting the positioning body function as base members. More specifically, the metal inserts may be fitted in these plastic blocks, for example, by a cut-and-fit inlay technique, in which the metal inserts are fitted in through holes formed in the plastic blocks constituting the base members. Further, the metal inserts may be fitted in these plastic blocks, for example, by a raised inlay technique, in which the metal inserts are fitted in the recesses formed in the plastic blocks constituting the base members such that they project from the surface of these plastic blocks. Further, the metal inserts may be fitted in this positioning body so as to be half-embedded by injecting plastic as a material of the positioning body around these metal inserts.

(4) In the roller hemming system of the present disclosure, the robot and the manipulator do not need to be a vertical multi-articulated robot. Specifically, a type of a robot or manipulator different than a vertical multi-articulated robot may be used, such as, for example, a horizontal multi-articulated robot as a part of the robot or manipulator.

What is claimed is:

1. A die for a roller hemming process, comprising:
a plastic positioning body configured to position a metal workpiece in a predetermined posture by being abutted to the metal workpiece; and
a metal inset attached to the plastic positioning body; wherein:
the plastic positioning body has an application portion configured to receive a bending force when an edge of the metal workpiece is bent back,
the metal insert is in a half-embedded state in the application portion, in which one part of the metal insert is exposed from a first surface of the application portion and another part is embedded inside the application portion, and
the metal insert has a higher surface hardness than the first surface of the application portion.

2. The die according to claim 1, wherein the metal insert protrudes higher as the metal insert closes a corner of the plastic positioning body.

3. The die according to claim 1, wherein the positioning body is comprises a plurality of plastic blocks made of hard and solid urethane resin.

4. The die according to claim 1, wherein the metal insert is located at a corner of the application portion.

5. The die according to claim 1, wherein the metal insert is located between two adjacent corners of the application portion.

6. A hemming system for performing a roller hemming process, comprising:
a die configured to have a metal workpiece therein;
a supporting means configured to support the metal workpiece from a side of the metal workpiece opposite the die; and
a robot having a roller, the robot being configured to control pressing of an edge of the metal workpiece with the roller, wherein:
the die includes a plastic positioning body configured to position the metal workpiece by being abutted to and along the edge of the metal workpiece;
the plastic positioning body includes a metal inset having a higher surface hardness than an application portion of the die, a pressing force being applied to the metal insert and the application portion when the edge of the metal workpiece is pressed by the roller so as to be bent back, and;
the metal insert, is half-embedded in the plastic positioning body, in which one part of the metal insert is exposed from a surface of the plastic positioning body and another part is embedded inside plastic positioning body.

7. The hemming sytsem for performing the roller hemming process according to claim 6, further comprising a manipulator for controlling a position and a posture of the die, wherein:
the supporting means is configured to bring the metal workpiece into a lifted state by supporting the metal workpiece; and
the manipulator is configured to allow the positioning body of the die to cover the metal workpiece supported by the supporting means, such that the metal insert is positioned along and contacts the edge of the metal workpiece.

8. A method for performing a roller hemming process, the method comprising:
setting a metal workpiece in a die, the die including a plastic positioning body and a metal insert;
abutting the plastic positioning body along an edge of the metal workpiece;
positioning the metal insert of the die along the edge of the metal workpiece; and
pressing the edge of the metal workpiece with a roller from a side of the metal workpiece opposite the positioning body.

9. The method for performing a roller hemming process according to claim 8, the method further comprising:
supporting the metal workpiece in a lifted state with a supporting means;
covering the metal workpiece with the die so that the metal workpiece is set in the die; and
placing the metal insert along the edge of the metal workpiece.

10. The method for performing a roller hemming process according to claim 8, wherein the edge of the metal workpiece is pressed with a greater force in an area overlapping the metal insert than an area not overlapping the metal insert.

11. The method for performing a roller hemming process according to claim 8, wherein the pressing step comprises the step of bending back the edge of the metal workpiece.

12. The method for performing a roller hemming process according to claim 11, wherein a portion of the edge overlapping the metal insert has a shorter bent-back width than a portion of the edge not overlapping the metal insert.

13. The method for performing a roller hemming process according to claim 11, wherein a greater bending force is applied to bend back a portion of the edge overlapping the metal insert than a portion of the edge overlapping the plastic positioning body.

14. The die according to claim 1, wherein the metal insert is also exposed from a second surface of the application portion, the second surface being perpendicular to the first surface.

15. The die according to claim 14, wherein the metal insert is also exposed from a third surface of the application portion, the third surface being perpendicular to both the first and second surfaces.

16. The hemming system for performing the roller hemming process according to claim 6, wherein the robot is configured to press the edge of the metal workpiece between the roller and the metal insert.

17. The hemming system for performing the roller hemming process according to claim 16, wherein the robot is further configured to press the edge of the metal workpiece with the roller from a side of the metal workpiece opposite to the positioning body.

18. A method for performing a roller hemming process, the method comprising:
setting a metal workpiece in a die;
pressing a first portion of an edge of the metal workpiece with a roller, the first portion overlapping a plastic portion of the die; and
pressing a second portion of the edge of the metal workpiece with the roller, the second portion overlapping a metal insert portion of the die, wherein:
the first portion is pressed with a first pressing force,
the second portion is pressed with a second pressing force, and
the second pressing force is greater than the first pressing force.

19. The hemming system for performing the roller hemming process according to claim 18, wherein the roller is maintained in contact with the edge of the metal workpiece between the first portion and the second portion.
